(19) United States
(12) Patent Application Publication
(10) Pub. No.: US 2026/0196189 A1
(43) Pub. Date: Jul. 9, 2026

(54) PROCESSING METHOD AND ELECTRONIC DEVICE

(71) Applicant: Lenovo (Beijing) Limited, Beijing (CN)

(72) Inventor: Binqiang MA, Beijing (CN)

(21) Appl. No.: 19/425,532

(22) Filed: Dec. 18, 2025

(30) Foreign Application Priority Data
Jan. 7, 2025 (CN) 202510025508.5

(51) Int. Cl. G09G 5/373

(52) U.S. Cl. CPC G09G 5/373; G09G 2340/04

(57) ABSTRACT

A processing method includes obtaining information, generating, in response to the information, a first signal and a second signal, and in response to the information indicating to increase a display area of a display region of a display apparatus, controlling to adjust a display parameter of the display region according to the second signal before controlling to adjust the display area of the display region according to the first signal.

### CROSS-REFERENCE TO RELATED APPLICATION

This application claims priority to Chinese Patent Application No. 202510025508.5, filed on Jan. 7, 2025, the entire content of which is incorporated herein by reference.

### TECHNICAL FIELD

The present disclosure generally relates to the display apparatus field and, more particularly, to a processing method and an electronic device.

### BACKGROUND

With the development of electronic devices, screens with adjustable display areas have increasingly attracted public attention. For example, in laptops, the display area of the screen may be adjusted to accommodate different display scenarios. During the process of adjusting the display area, how to optimize the display performance while the screen is in action remains an issue to be addressed.

### SUMMARY

In accordance with the disclosure, there is provided a processing method including obtaining information, generating, in response to the information, a first signal and a second signal, and in response to the information indicating to increase a display area of a display region of a display apparatus, controlling to adjust a display parameter of the display region according to the second signal before controlling to adjust the display area of the display region according to the first signal.

Also in accordance with the disclosure, there is provided an electronic device including a first body, a second body having a face and rotatably connected to the first body with a relative positional relationship between the second body and the first body being adjustable, a display apparatus with a display region forming the face and a display area configured to change as a state of the second body changes, and a processor configured to obtain information, generate, in response to the information, a first signal and a second signal, and in response to the information indicating to increase a display area of a display region of a display apparatus, control to adjust a display parameter of the display region according to the second signal before control to adjust the display area of the display region according to the first signal.

Also in accordance with the disclosure, there is provided a processing method including receiving a first signal and a second signal, and in response to the first signal indicating to increase a display area of a display region of a display apparatus from a first display area to a second display area, controlling to adjust a display parameter of the display region according to the second signal before controlling to adjust the display area of the display region according to the first signal.

### BRIEF DESCRIPTION OF THE DRAWINGS

FIG. 1 is a flowchart of a processing method consistent with the present disclosure.

FIG. 2 is a flowchart of a processing method consistent with the present disclosure.

FIG. 3 is a flowchart of a processing method in a roll-in scenario consistent with the present disclosure.

FIG. 4 is a flowchart of a processing method in a roll-out scenario consistent with the present disclosure.

FIG. 5 is a schematic diagram of an electronic device consistent with the present disclosure.

### DETAILED DESCRIPTION OF THE EMBODIMENTS

Various solutions and features of the present disclosure are described herein with reference to the accompanying drawings.

It should be understood that various modifications may be made to the embodiments of the disclosure herein. Therefore, the above description should not be taken as limiting, but merely as exemplification of the embodiments. Other modifications within the scope and spirit of the disclosure can be conceived by those skilled in the art.

The accompanying drawings, which are incorporated in and constitute a part of this specification, illustrate embodiments of the disclosure and, together with a general description of the disclosure given above, and the detailed description of the embodiments given below, serve to explain the principles of the disclosure.

These and other features of the disclosure will become apparent from the following description of embodiments, given as non-limiting examples, with reference to the accompanying drawings.

It is also to be understood that, although the disclosure has been described with reference to some specific examples, a person skilled in the art will certainly be able to achieve many other equivalent forms of the disclosure.

The above and other aspects, features and advantages of the present disclosure will become more apparent in light of the following detailed description when taken in conjunction with the accompanying drawings.

Specific embodiments of the present disclosure are described hereinafter with reference to the drawings. However, it should be understood that the embodiments described are merely examples of the present disclosure and may be implemented in various forms. Accordingly, the specific structural and functional details of the embodiments described herein are not intended to be limiting, but rather are provided as the basis for the claims and as representative examples for teaching those skilled in the art to use the present disclosure in a variety of suitable detailed structures.

The specification may use the phrases “in some embodiments,” “in another embodiment,” “in yet another embodiment,” or “in other embodiments,” which may each refer to one or more of the same or different embodiments in accordance with the disclosure.

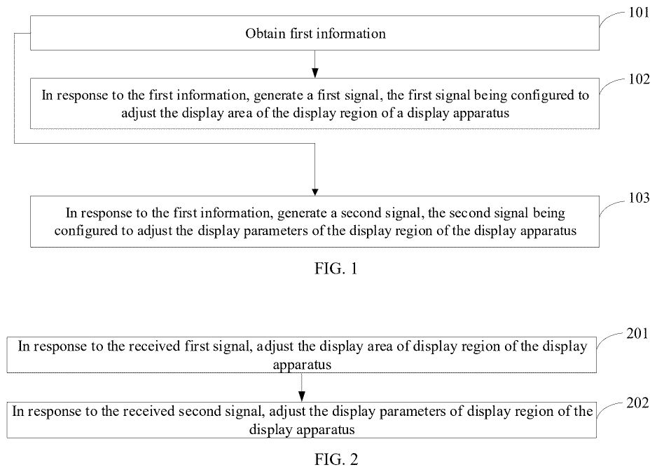

The processing method of the present disclosure will be described in detail below with reference to the accompanying drawings. FIG. 1 is a flowchart of a processing method consistent with the present disclosure. As shown in FIG. 1, the method includes the following.

At 101, first information is obtained.

The first information is configured to indicate that the display apparatus needs to switch its mode. For example, the first information can be used to indicate that the display apparatus is to switch to a large-area display mode, or the first information can be used to indicate that the display apparatus is to switch to a small-area display mode.

In some embodiments, the first information may be information generated based on user operations. For example, input information generated by users through input devices such as keyboard, mouse, or touchpad may be used as the first information.

In some embodiments, the first information may be automatically generated based on the display requirements of current display content. For example, if a target application requires the display area of the display apparatus to be a large display area, the first information may be generated based on the target application switching display mode.

Taking a laptop as an example, the first information indicating that the mode of the display apparatus needs to be switched may be obtained through an embedded controller (EC), a central processing unit (CPU), or the like.

At 102, in response to the first information, a first signal is generated, the first signal being used to adjust the display area of the display region of the display apparatus. In this disclosure, “display area” of the display region can refer to the two-dimensional size of the display region.

The present solution applies to electronic devices having display apparatuses with variable display areas, such as mobile phones, tablets, and laptops. For ease of understanding the technical solutions intended to be protected by the embodiments of the present disclosure, the following description will use a laptop as an example.

Specifically, a laptop includes a first body and a second body with an adjustable relative position. The display region of the display apparatus may form a first face of the second body. A bracket of the second body may expand and retract to adjust the size of the second body, thereby changing the display area of the display region of the display apparatus.

When the bracket of the second body is in a retracted state, the area of the portion of the display region forming the first face is smaller than the total area of the display region of the display apparatus. When the bracket of the second body is in an extended state, the area of the portion of the display region forming the first face forming the first face is larger than the area of the portion of the display region forming the first face when the bracket is in the retracted state.

When the bracket is in the retracted state, the portion of the display region not forming the first face may be located in the first body. For example, if the first body is provided with a keyboard, the portion of the display region not forming the first face may be located beneath the keyboard so as not to affect keyboard use. As another example, the portion of the display region not forming the first face may be located in the second body and covered by a second face of the second body, the second face being opposite to the first face.

For ease of description, adjusting the display region of the display apparatus from a large area to a small area will be referred to herein as roll-in, and adjusting the display region from a small area to a large area will be referred to as roll-out.

If adjustment of the display area is implemented through motor drive, the first signal may be output to a motor controller. The motor controller controls the motor to move the screen to adjust the display area of the display region of the display apparatus, for example, increase or decrease the display area of the display region, thereby enables the display to roll-out and roll-in. Hereinafter, the display apparatus will be referred to as the screen.

At 103, in response to the first information, a second signal is generated, the second signal being used to adjust the display parameters of the display region of the display apparatus.

The second signal is provided to a processor such as a CPU of the electronic device to adjust the display parameters of the display region of the display apparatus. The display parameters may include display aspect ratio and/or screen resolution.

If the first information indicates increasing the display area of the display region of the display apparatus from a first display area to a second display area, the time for adjusting the display parameters of the display region of the display apparatus is earlier than the time for adjusting the display area of the display region of the display apparatus.

If the first information indicates increasing the display area of the display region of the display apparatus from the first display area to the second display area, since the screen roll-out operation increases the display area visible to the user, the newly added display region may show black screen during the roll-out process, resulting in poor user experience.

To address the above problem, the solution provided in the present disclosure, after obtaining the first information indicating roll-out, can adjust the display area of the display region of the display apparatus through a generated first signal and adjust the display parameters of the display apparatus through a generated second signal. That is, the first signal enables screen movement, and the second signal enables adjustment of the screen display content. Since the time for adjusting the display parameters of the display region of the display apparatus is earlier than the time for adjusting the display area of the display region of the display apparatus, the display parameters are ready by the time roll-out occurs. The content displayed on the screen therefore already matches display area of the expanded display region, preventing newly added region (i.e., the display region is adjusted from a state that is not visible to the user to a state that is visible to the user) from showing black screen, and improving visual performance of the display.

In some embodiments, if the first information indicates decreasing the display area of the display region of the display apparatus from a third display area to a fourth display area, the time for adjusting the display area of the display region of the display apparatus is earlier than the time for adjusting the display parameters of the display region of the display apparatus.

The first display information is configured to reduce the display area of the display region of the display apparatus from a third display area to a fourth display area. This means that the first information indicates roll-in, which differs from “roll-out.” Roll-in has the issue of partial display region being blocked. Therefore, it allows for screen movement followed by adjustment of the display parameters of the display region. During the movement, the screen is always displaying content, so it will not show a black screen.

The present disclosure can avoid not only the black screen problem during roll-out, but the problem of partial display region being blocked during roll-in.

In some embodiments, the first information being used to increase the display area of the display region of the display apparatus from a first display area to a second display area, the method further includes outputting a first signal at a first moment, and outputting a second signal at a second moment.

The second moment being earlier than the first moment.

For the roll-out operation, to allow sufficient time to adjust the display parameters of the display region of the display apparatus before adjusting the display area of the display region of the display apparatus, the second signal is output earlier than the first signal. For example, the second moment can be 100 ms earlier than the first moment (this time is only one example, and the specific time interval can be adjusted according to product needs). Consistent with present disclosure, through adjusting the output time of the first signal and the second signal, allowing sufficient time for the display parameters of the display region of the display apparatus to be adjusted, thus avoiding the impact on the user's visual experience when the display parameters have not been adjusted while the display area is being adjusted.

As shown in FIG. 2, embodiments of the present disclosure provide a processing method. The method includes the following.

At 201, in response to the received first signal, the display area of display region of the display apparatus is adjusted.

The method applies to a system and may be implemented by a processor supporting the system. This method corresponds to the previous processing method, the description of the first signal and second signal in the previous method also applies to this method.

At 202, in response to the received second signal, the display parameters of display region of the display apparatus are adjusted.

If the first signal indicates increasing the display area of the display region of the display apparatus from the first display area to the second display area, the time for adjusting the display parameters of the display region of the display apparatus is earlier than the time for adjusting the display area of display region of the display apparatus.

The embodiments of present disclosure can adjust the display area based on a first signal and adjust the display parameters based on a second signal. Since the time for adjusting the display parameters of the display region of the display apparatus is earlier than the time for adjusting the display area of display region of the display apparatus, the adjustment of display parameters of the display region has been completed when the screen rolls out, ensuring that the displayed content fits the display area of the expanded display region and preventing a black screen on the newly expanded portion, thus improving the visual experience.

In some embodiments, if the first signal indicates decreasing the display area of the display region of the display apparatus from a third display area to a fourth display area, the adjustment time for the display area of the display region of the display apparatus is earlier than the adjustment time for the display parameters of the display region of the display apparatus.

If the first signal indicates decreasing the display area of the display region of the display apparatus from a third display area to a fourth display area, the first signal indicates roll-in, the screen may be moved first and then display parameters of display region can be adjusted afterward. During the movement, the screen continuously displays content, thus preventing black screen issue. The embodiments of the present disclosure not only avoid the black screen issue during the roll-out process but also prevents the partial blocking of the display area during the roll-in process.

In some embodiments, the display apparatus can output display images based on information to be displayed. The information to be displayed includes a first region and a second region. The first region is used to display an application's display interface, and the second region is used to display the application's display status. The method further includes the following.

In response to the received first signal, adjusting the display area of the display region of the display apparatus includes the following.

If the first signal indicates increasing the display area of the display region of the display apparatus from the first display area to the second display area, controlling the second region to be invisible during the change of display region.

If the first signal indicates decreasing the display area of the display region of the display apparatus from the third display area to the fourth display area, controlling the second region to be invisible during the change of display region.

Consistent with the present disclosure, the second region displays application's display status, (e.g., the second region displays a taskbar). During roll-in and roll-out, the second region remains invisible. Hiding the second region prevents frequent changes in content displayed in the second region during roll-in and roll-out that affect user visual experience, thus improving overall visual quality.

In some embodiments, if the first signal indicates increasing the display area of the display region of the display apparatus from the first display area to the second display area, controlling the second region to be invisible during the change of display region includes the following.

Determining the target display position of the second region on the display apparatus based on the display parameters of the display apparatus corresponding to the second display area, the target display position corresponding to a displayable region that corresponds to an invisible part of the display apparatus under the first display area.

During expansion of the display area of the display region from the first display area to the second display area, controlling the second region to be displayed at the target display position, i.e., the second region is controlled to be displayed at the target display position after the display area of the display region reaches the second display area.

The position of the second region is determined based on the display parameters corresponding to the second display area. During roll-out, although the second region is not displayed to the user on the currently visible display region, the position of the second region is the target display position. Consistent with the present disclosure, adjusting the target display position based on the display parameters corresponding to the second display area allows the second region to adaptively adjust its display position according to changes in screen size after roll-out, thereby improving the display visual performance of the screen.

In some embodiments, if the first signal indicates decreasing the display area of the display region of the display apparatus from the third display area to the fourth display area, controlling the second region to be invisible during the change of display region includes during reduction of the display area of the display region of the display apparatus from the third display area to the fourth display area, the display position of the second region remains unchanged.

In some embodiments, during roll-in, as the screen retracts, the display position of the second region moves beneath the keyboard and therefore, to the user, the second region is not displayed on the screen. The display position of the second region remains unchanged means the position within the display apparatus, not the position within the currently visible display region to the user.

In some embodiments, the display apparatus can output a display image based on the information to be displayed. If the first signal indicates decreasing the display area of the display region of the display apparatus from the third display area to the fourth display area, the method further includes the following.

Preloading information to be displayed in response to receiving the first signal.

In response to the display area of the display region of the display apparatus being the fourth display area, outputting a display image corresponding to the information to be displayed based on the information to be displayed.

The information to be displayed may include resources of a display manager, such as animations or image data. For roll-in, the client terminal may preload the information to be displayed through invoking a display manager query interface and output the display image corresponding to the information to be displayed when the display area reaches the fourth display area, allowing the screen to display the image.

Consistent with present disclosure, by preloading the information to be displayed, the corresponding display image can be displayed in a timely manner during roll-in until the display area of the screen reaches the fourth display area, reducing the latency of updating the display content and improving the screen display performance.

In some embodiments, if the first signal indicates increasing the display area of the display region of the display apparatus from the first display area to the second display area, the method further includes the following.

Loading information to be displayed in response to receiving the first signal.

Outputting display images corresponding to the information to be displayed based on the information to be displayed.

Adjusting the display area of the display region in response to the first signal.

For roll-out, the information to be displayed can also include resources of the display manager, such as animations. The client terminal can preload the information to be displayed through invoking a display manager query interface. Unlike roll-in, screen roll-out requires outputting the display image corresponding to the information to be displayed directly after loading is complete to switch the screen display content, and then start moving the screen. The embodiments of this disclosure can prevent the screen from going black during the roll-out process, thereby improving the screen display performance.

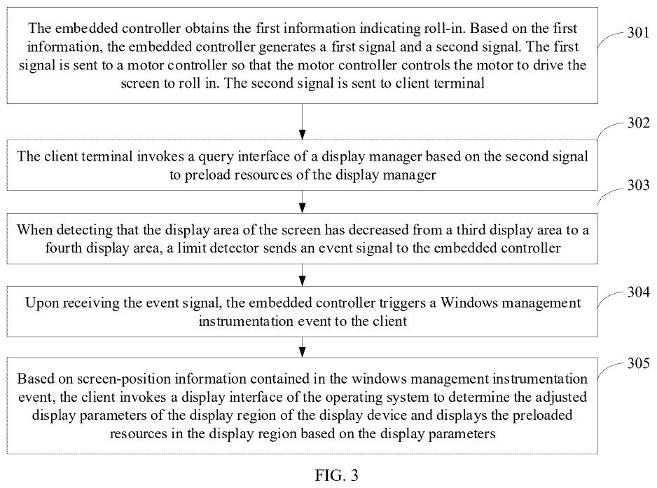

As shown in FIG. 3, embodiments of the present disclosure provide a processing method, which includes the following.

At 301, the first information indicating roll-in is obtained by the embedded controller. Based on the first information, a first signal and a second signal are generated by the embedded controller. The first signal is sent to a motor controller so that the motor controller controls the motor to drive the screen to roll in. The second signal is sent to a system program.

At 302, a query interface of a display manager is invoked by the system program based on the second signal to preload resources of the display manager.

At 303, when the display area of the screen is detected to have decreased from a third display area to a fourth display area, an event signal is sent to the embedded controller by a limit detector.

For example, the screen size is 15.3 inches prior to roll-in, after roll-in, the screen size is 12.7 inches. The portion of the screen that rolls in is accommodated in a space beneath the keyboard.

At 304, when the event signal is received, a Windows management instrumentation (WMI) event to the client is triggered by the embedded controller.

At 305, based on screen-position information contained in the WMI event, a display interface of the operating system is invoked by the client to determine the adjusted display parameters of the display region and display the preloaded resources in the display region based on the display parameters.

Consistent with the present disclosure, the display parameters of the display region of the screen can be adjusted in a timely manner during roll-in, preventing displayed content from being blocked during roll-in and improving display performance.

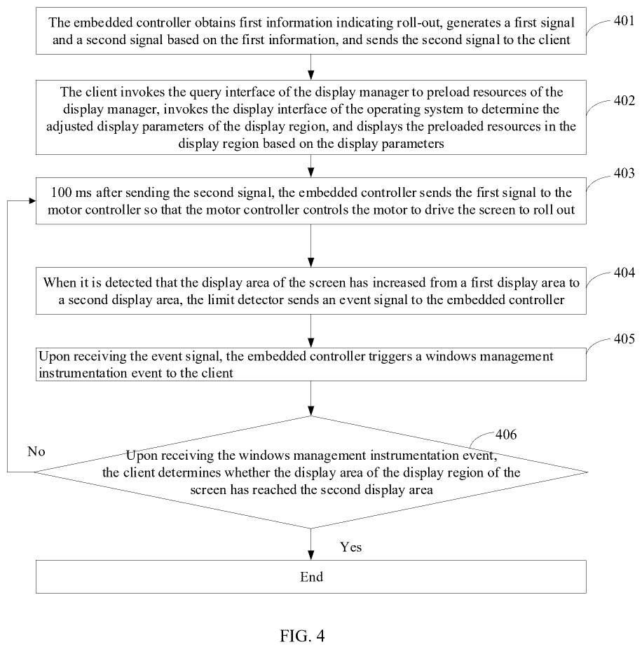

As shown in FIG. 4, embodiments of the present disclosure provide a processing method, which includes the following.

At 401, first information indicating roll-out is obtained by the embedded controller, a first signal and a second signal are generated based on the first information, and the second signal is sent to the client.

At 402, the query interface of the display manager is invoked by the client to preload resources of the display manager, the display interface of the operating system is invoked to determine the adjusted display parameters of the display region and display the preloaded resources in the display region based on the display parameters.

At 403, 100 ms after the second signal is sent, the first signal is sent to the motor controller by the embedded controller so that the motor controller controls the motor to drive the screen to roll out.

At 404, when it is detected that the display area of the screen has increased from a first display area to a second display area, an event signal is sent to the embedded controller by the limit detector.

Before roll-out, the screen size is 12.7 inches, and the screen size is 15.3 inches after roll-out.

At 405, upon receiving the event signal, a WMI event is triggered to the client by the embedded controller.

At 406, upon receiving the WMI event, whether the display area of the display region of the screen has reached the second display area is determined by the client. If the display area of the display region of the screen has reached the second display area, the current process is terminated. If not, the process at 403 is executed.

If the display area of the display region of the screen has not reached the second display area, continue to execute 403 to further control roll-out through the motor controller. A prompt may also be displayed to inform the user that roll-out is incomplete, and the user may confirm whether to continue roll-out. The screen can also prompt the user that the display area has not reached the second display area after screen roll-out, and the user can confirm whether to continue to roll out the screen.

When shutdown is detected, the embedded controller may also generate a roll-in control instruction. Through this instruction, the screen is rolled back to its pre-roll-out position, i.e., returned to the state before roll-out, thereby avoiding situations in which the laptop cannot be closed after shutdown.

The embedded controller may further receive events indicating motor pauses and send pause information to the client, allowing the client to notify the user of the motor pause based on the pause information. The user may check whether the motor is malfunctioning based on the pause information.

Consistent with the present disclosure, during roll-out, switching display content prior to screen movement prevents black screen issue and improves display performance.

The present disclosure further provides an electronic device, which includes the following.

A first body.

A second body having a first face, rotatably connected to the first body, the relative positional relationship between the first body and second body being adjustable.

A display apparatus having a display region forming a first face, where changes in the state of the second body can cause a change in the display area of the portion of the display region forming the first face.

A first processing apparatus configured to adjust the display area of the display region of the display apparatus in response to a received first signal, and adjust the display parameters of the display region of the display apparatus in response to a received second signal.

If the first signal is configured to increase the display area of the display region of the display apparatus from a first display area to a second display area, controlling the adjustment of the display parameters of the display region of the display apparatus occurs earlier than the adjustment of the display area of the display region of the display apparatus.

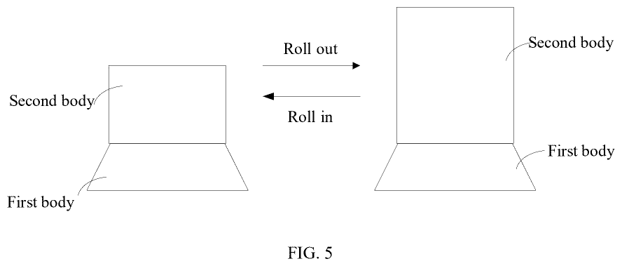

As shown in FIG. 5, the relative positional relationship between the second body and the first body may be adjusted through roll-in and roll-out operations.

The increase of the display area means the second body moves in a direction away from the first body so that the size of the screen of the display apparatus increases in the direction away from the first body. Taking a laptop as an example, the first body is where the keyboard is located, and the second body is where the screen is located. The first processing apparatus can be an embedded controller.

In some embodiments, the display apparatus outputs display images based on information to be displayed. The information to be displayed includes a first region and a second region. The first region displays an application's display interface, and the second region displays an application's display status. The first processing apparatus is further configured to do the following.

If the first signal indicates increasing the display area of the display region of the display apparatus from the first display area to the second display area, determine a target display position of the second region on the display apparatus based on the display parameters of the display apparatus corresponding to the second display area, the target display position corresponding to a displayable region of the display apparatus that is covered by the first body under the first display area.

If the first signal indicates decreasing the display area of the display region of the display apparatus from the third display area to the fourth display area, control the display position of the second region to remain unchanged during the change of display region.

In some embodiments, the electronic device further includes a driving device configured to drive the state change of the second body so that the display size of the display region forming the first face changes.

In some embodiments, if the first information indicates increasing the display area of the display region of the display apparatus from the first display area to the second display area, the first processing apparatus is further configured to output the first signal at a first moment, output the second signal at a second moment, the second moment being earlier than the first moment.

The present disclosure also provides a processing apparatus, which includes the following.

An obtaining module configured to obtain first information.

A generation module configured to generate a first signal in response to the first information, the first signal being used to adjust the display area of the display region of the display apparatus. The generation module is also configured to generate a second signal in response to the first information, the second signal being used to adjust the display parameters of the display region of the display apparatus.

If the first information indicates increasing the display area of the display region of the display apparatus from a first display area to a second display area, the adjustment of the display parameters of the display region of the display apparatus occurs earlier than the adjustment of the display area of the display region of the display apparatus.

In some embodiments, the processing apparatus further includes an output module configured to, if the first information indicates increasing the display area of the display region of the display apparatus from the first display area to the second display area, output the first signal at a first moment, output the second signal at a second moment, second moment being earlier than the first moment.

The present disclosure provides a processing apparatus which includes the following.

A first adjustment module configured to adjust the display area of the display region of the display apparatus in response to a received first signal.

A second adjustment module configured to adjust the display parameters of the display region of the display apparatus in response to a received second signal.

If the first signal indicates increasing the display area of the display region of the display apparatus from a first display area to a second display area, the adjustment of the display parameters of the display region of the display apparatus occurs earlier than the adjustment of the display area of the display region of the display apparatus.

In some embodiments, the display apparatus outputs display images based on information to be displayed. The information to be displayed includes a first region and a second region. The first region displays an application's display interface, and the second region displays an application's display status. The first adjustment module is further configured to, if the first signal indicates increasing the display area of the display region of the display apparatus from the first display area to the second display area, control the second region to remain invisible during the change of display region. The first adjustment module can be also further configured to, if the first signal indicates decreasing the display area of the display region of the display apparatus from the third display area to the fourth display area, controlling the second region to remain invisible during the change of display region.

In some embodiments, if the first signal indicates increasing the display area of the display region of the display apparatus from the first display area to the second display area, controlling the second region to remain invisible during the change of display region includes, determining a target display position of the second region on the display apparatus based on the display parameters of the display apparatus corresponding to the second display area, the target display position corresponding to a displayable region that is part of an invisible region under the first display area, and during expansion of the display area of the display region of the display apparatus from the first display area to the second display area, controlling the second region to be displayed at the target display position.

In some embodiments, the first adjustment module is further configured to, during reduction of the display area of the display region of the display apparatus from the third display area to the fourth display area, control the display position of the second region remains unchanged.

In some embodiments, the display apparatus can output display images based on information to be displayed. If the first signal indicates decreasing the display area of the display region of the display apparatus from the third display area to the fourth display area, the first adjustment module is configured to preload the information to be displayed in response to receiving the first signal, and output the display image corresponding the information to be displayed based on the information to be displayed in response to the display area of the display region of the display apparatus reaches the fourth display area.

Embodiments of the present disclosure further provide a storage medium. The storage medium carries one or more computer programs, and when the one or more computer programs are executed by a processor, the above-described method is implemented.

The electronic device described in the embodiments of the present disclosure may be a terminal, or any other device besides a terminal. For example, the electronic device can be a tablet, laptop, portable computer, in-vehicle electronic device, mobile internet device (MID), augmented reality (AR)/virtual reality (VR) device, robot, wearable device, ultra-mobile personal computer (UMPC), netbook, personal digital assistant (PDA), or the like, and may also be a server, network attached storage (NAS), personal computer (PC), television (TV), automated teller machine (ATM), or self-service machine, etc.

The above-mentioned processor may be a general-purpose processor, including a CPU or a network processor (NP). The processor may also be a digital signal processor (DSP), an application specific integrated circuit (ASIC), a field programmable gate array (FPGA), or other programmable logic devices, discrete gate or transistor logic devices, or discrete hardware components.

The embodiments of the present disclosure may be implemented wholly or partially by software, hardware, firmware, or any combination thereof. When implemented using software, the embodiments of the present disclosure may be embodied wholly or partially as a computer program product. The computer program product includes one or more computer instructions. When the computer program instructions are loaded and executed on a computer, some or all of the flows or functions described in the embodiments of the present disclosure are generated. The computer may be a general-purpose computer, a special-purpose computer, a computer network, or any other programmable device. The computer instructions may be stored in a computer-readable storage medium, or transmitted from one computer-readable storage medium to another. For example, the computer instructions may be transmitted from one website, computer, server, or data center to another website, computer, server, or data center via wired means (e.g., coaxial cable, optical fiber, digital subscriber line) or wireless means (e.g., infrared, radio, microwave). The computer-readable storage medium may be any available medium accessible by a computer or may be a data storage device such as a server or data center including one or more available media. The available media may include magnetic media (e.g., floppy disk, hard disk, magnetic tape), optical media (e.g., DVD), or semiconductor media (e.g., solid-state drive), etc. The above embodiments are merely exemplary embodiments of the present disclosure and are not intended to limit the present disclosure. The scope of protection of the present disclosure is defined by the appended claims. Various modifications or equivalent substitutions may be made to the present disclosure by those skilled in the art within the spirit and scope of the present disclosure, and such modifications or equivalent substitutions shall also fall within the scope of the present disclosure.

What is claimed is:

1. A processing method comprising:
obtaining information;
generating, in response to the information, a first signal;
generating, in response to the information, a second signal; and
in response to the information indicating to increase a display area of a display region of a display apparatus, controlling to adjust a display parameter of the display region according to the second signal before controlling to adjust the display area of the display region according to the first signal.

2. The method according to claim 1, further comprising:
in response to the information indicating to decrease the display area of the display region from a third display area to a fourth display area, controlling to adjust the display area of the display region according to the first signal before controlling to adjust the display parameter of the display region according to the second signal.

3. The method according to claim 1, further comprising, in response to the information indicating to increase the display area of the display region:
outputting the first signal at a first moment; and
outputting the second signal at a second moment earlier than the first moment.

4. A non-transitory computer-readable storage medium storing a program that, when executed by a processor, cause an electronic device including the processor to perform the method according to claim 1.

5. An electronic device comprising:
a first body;
a second body having a face and rotatably connected to the first body, a relative positional relationship between the second body and the first body being adjustable;
a display apparatus, a display region of the display apparatus forming the face, and a display area of the display region being configured to change as a state of the second body changes; and
a processor configured to:
obtain information;
generate, in response to the information, a first signal;
generate, in response to the information, a second signal; and
in response to the information indicating to increase the display area of the display region, control to adjust a display parameter of the display region according to the second signal before controlling to adjust the display area of the display region according to the first signal.

6. The electronic device according to claim 5, wherein the processor is further configured to:
in response to the information indicating to decrease the display area of the display region from a third display area to a fourth display area, control to adjust the display area of the display region according to the first signal before controlling to adjust the display parameter of the display region according to the second signal.

7. The electronic device according to claim 5, wherein the processor is further configured to, in response to the information indicating to increase the display area of the display region:
output the first signal at a first moment; and
output the second signal at a second moment earlier than the first moment.

8. A processing method comprising:
receiving a first signal; and
receiving a second signal; and
in response to the first signal indicating to increase a display area of a display region of a display apparatus from a first display area to a second display area, controlling to adjust a display parameter of the display region according to the second signal before controlling to adjust the display area of the display region according to the first signal.

9. The method according to claim 8, further comprising:
in response to the first signal indicating to decrease the display area of the display region from a third display area to a fourth display area, controlling to adjust the display area of the display region according to the first signal before controlling to adjust the display parameter of the display region according to the second signal.

10. The method according to claim 9,
wherein the display apparatus is configured to output a display image based on information to be displayed, the information to be displayed including a first region and a second region, the first area being configured to display a display interface of an application, and the second region being configured to display a display status of the application;
the method further comprising:
controlling the second region to be in an invisible state during a process of changing the display area.

11. The method according to claim 10, wherein, in response to the first signal indicating to decrease the display area of the display region, controlling the second region to be in the invisible state during the process of changing the display area includes controlling a display position of the second region to remain unchanged during the process of decreasing the display area of the display region.

12. The method according to claim 9, further comprising, in response to the first signal indicating to decrease the display area of the display region from the third display area to the fourth display area:
preloading information to be displayed in response to receiving the first signal; and
outputting, in response to the display area of the display region reaching the fourth display area, a display image based on the information to be displayed.

13. The method according to claim 8,
wherein the display apparatus is configured to output a display image based on information to be displayed, the information to be displayed including a first region and a second region, the first area being configured to display a display interface of an application, and the second region being configured to display a display status of the application;
the method further comprising:
controlling the second region to be in an invisible state during a process of changing the display area.

14. The method according to claim 13, wherein, in response to the first signal indicating to increase the display area of the display region from the first display area to the second display area, controlling the second region to be in the invisible state during the process of changing the display area includes:
determining a target display position of the second region on the display apparatus according to a display parameter corresponding to the second display area, the target display position corresponding to a displayable region that is an invisible part of the display region under the first display area; and
controlling the second region not to display at the target display position during the process of increasing the display area of the display region from the first display area to the second display area.

15. An electronic device comprising:
a first body;
a second body having a face and rotatably connected to the first body, a relative positional relationship between the second body and the first body being adjustable;
a display apparatus, a display region of the display apparatus forming the face, and a display area of the display region being configured to change as a state of the second body changes; and
a processor configured to perform the method according to claim 8.

16. The electronic device according to claim 15, wherein:
the display apparatus is configured to output a display image based on information to be displayed, the information to be displayed including a first region and a second region, the first region being configured to display a display interface of an application, and the second region being configured to display a display status of an application; and
the processor is further configured to:
in response to the first signal indicating to increase the display area of the display region from the first display area to the second display area, determine a target display position of the second region on the display apparatus according to a display parameter corresponding to the second display area, the target display position corresponding to a portion of the display region that is covered by the first body under the first display area.

17. The electronic device according to claim 15, wherein the processor is further configured to:
in response to the first signal indicating to decrease the display area of the display region from a third display area to a fourth display area, control to adjust the display area of the display region according to the first signal before controlling to adjust the display parameter of the display region according to the second signal.

18. The electronic device according to claim 17, wherein:
the display apparatus is configured to output a display image based on information to be displayed, the information to be displayed including a first region and a second region, the first region being configured to display a display interface of an application, and the second region being configured to display a display status of an application; and
the processor is further configured to:
in response to the first signal indicating to decrease the display area of the display region of the display apparatus, control a display position of the second region to remain unchanged during a process of changing the display are.

19. The electronic device according to claim 15, wherein:
the display apparatus is configured to output a display image based on information to be displayed, the information to be displayed including a first region and a second region, the first area being configured to display a display interface of an application, and the second region being configured to display a display status of the application; and
the processor is further configured to:
control the second region to be in an invisible state during a process of changing the display area.

20. A non-transitory computer-readable storage medium storing a program that, when executed by a processor, cause an electronic device including the processor to perform the method according to claim 8.
